(19) United States
(12) Patent Application Publication
(10) Pub. No.: US 2009/0265716 A1
(43) Pub. Date: Oct. 22, 2009

(54) SYSTEM AND METHOD FOR FEATURE ADDITION TO AN APPLICATION

(75) Inventor: BC Prashanth, Bangalore (IN)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munich (DE)

(21) Appl. No.: 12/107,221

(22) Filed: Apr. 22, 2008

(51) Int. Cl. G06F 9/54

(52) U.S. Cl. 719/312

(57) ABSTRACT

A system (10) for providing a feature to a software application (12) comprises an intercepting component (14) and a service providing component (18). The service providing component (18) comprises code adapted for providing said feature to said application (12). The intercepting component (14) comprises code adapted for intercepting a first user interaction with said application (12) and communicating the intercepted user interaction to the service providing component (18). The code of the service providing component (18) is adapted to provide said feature to said application (12) by communicating, to said application (12), a simulation of at least one second user interaction with said application (12), based upon the intercepted first user interaction communicated by the intercepting component (14).

### FIELD OF INVENTION

The present invention relates to a system and method for providing an additional non-exiting feature to an existing software application.

### BACKGROUND OF INVENTION

In software engineering, it is often desirable to enhance the capability of an existing application by providing one or more additional features the application. This is currently done by incorporating plug-ins to the application. For example, in VC++ editor, an additional feature of auto-completion may be provided by an active X plug-in, or add-in, such as ‘Visual Assist’, However, the above approach is not feasible in an application that does not support plug-in features. An alternate approach to providing an additional feature to an application is to modify the source code of the application. However, modifying the source code of an application affects the behavior of the application and also increases the complexity and turnaround time with respect to the development, testing and maintenance of the application.

Hence, it is desirable to have an improved system and method for providing an additional feature to an existing software application.

### SUMMARY OF INVENTION

Accordingly, the present invention deals with a system and method for enhancing the capabilities of an exiting software application by providing a non-existent feature within the scope of that application without changing its source code or behavior. Briefly, according to one aspect of the present invention, a system for providing a feature to a software application comprises an intercepting component and a service providing component. The service providing component comprises code adapted for providing said feature to said application. The intercepting component comprises code adapted for intercepting a first user interaction with said application and communicating the intercepted user interaction to the service providing component. The service providing component is adapted to provide said feature to said application by communicating, to said application, a simulation of at least one second user interaction with said application, based upon the intercepted first user interaction communicated by the interceptor.

In accordance with another aspect of the present invention, a computer implemented method is provided that includes intercepting a first user interaction with a software application. The method further includes simulating at least one second user interaction with said application, based upon the intercepted first user interaction with the application. The simulated at least one second user interaction is then communicated to said application.

### BRIEF DESCRIPTION OF THE DRAWINGS

The present invention is further described hereinafter with reference to exemplary embodiments shown in the accompanying drawings, in which:

FIG. 1 is a functional block diagram of the components of the system for providing a feature to an application,

FIG. 2 is a schematic block diagram illustrating the use present invention in multiple application,

FIG. 3 is a flowchart illustrating an exemplary method for providing a feature of auto-completion of words to an application,

FIG. 4 is a screenshot illustrating the feature of auto-completion of words provided to a text editor,

FIG. 5 is a schematic screenshot illustrating the feature of auto-completion of words provided to a word processing application, and

FIG. 6 is a schematic screenshot illustrating the feature of auto-completion of words provided to a medical application.

### DETAILED DESCRIPTION OF INVENTION

The present invention provides a system and method for enhancing the capabilities of a software application by providing a non-existing feature within the scope of that application without changing its source code or behavior. This is achieved by using a loosely coupled interceptor and simulation technique as described hereinafter in the illustrated embodiments.

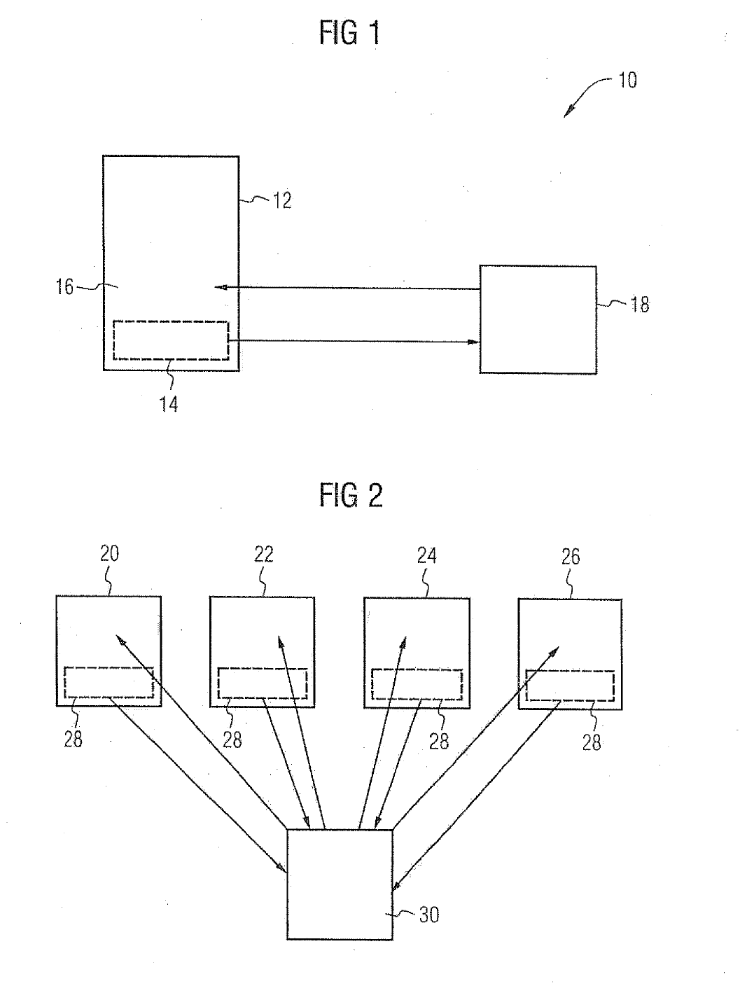

Referring to FIG. 1 is illustrated a system 10 for providing a feature to a software application 12. The business logic of this feature is contained in a service providing component 18 that comprises software code adapted for providing the feature to the application 12. In accordance with the present invention, the system 10 includes an intercepting component 14 comprising software code for intercepting a user interaction with the application 12 and communicating the same to the service providing component 18. In a preferred embodiment, the intercepting code resides in a process space 16 of the application 12. The process space 16 of the application 12, also referred to as the virtual address space of the application, is the location in the memory that is occupied by the application 12 when it is executed. The details about all the resources used by the application 12, the actual executable code etc are stored in the address space 16. Hence, when the intercepting code is executed in the process space 16 of the application 12 that is being executed, the details of the resources used by the application 12 (for example, information regarding the windows, buttons etc) can be easily obtained by the intercepting code, and communicated to the service providing component 18 based upon which the service providing component 18 provides the added feature to the application 12.

The intercepting code running in the application's process space 16 is typically a light weight code such as, for example, a global keyboard hook that intercepts every keyboard interaction (i.e., key press) of a user with the application 12, and communicates the same to the service providing component 18. Additionally, the intercepting code also provides information regarding the process state and process resources of the application 12 to the service providing component 18. The process state of an application is defined as the stage of execution (i.e. created ready, running, terminated, etc) that the application is in. In case of a windows based application, process resource information may include, for example, the window handle of the active window of the application. Based on the information supplied by the intercepting code, the service providing component 18 provides the added feature to the application 12 by simulating a sequence of user interactions (i.e., key presses, in this example) and communicating the same to the application 12. For example, if the application 12 is windows based application, the service providing component 18 provides the added feature to the application 12 by simulating the sequence of key presses and sending corresponding windows keyboard messages the application 12, which assumes that the messages are generated due to key press by the user.

The proposed intercept-simulation model can be used to provide a particular feature to multiple applications. As illustrated in FIG. 2, multiple applications 20, 22, 24, 26 can be provided with an added feature by a single service providing component 30 containing the business logic of that feature. Each of the applications 20, 22, 24 26 has an intercepting component 28 executed in their respective process spaces that communicate user interactions, process states and process resources of the respective application to the service providing component 30 based upon which the service providing component provides the added feature to the respective application by simulation of a user interaction with that application, as described above.

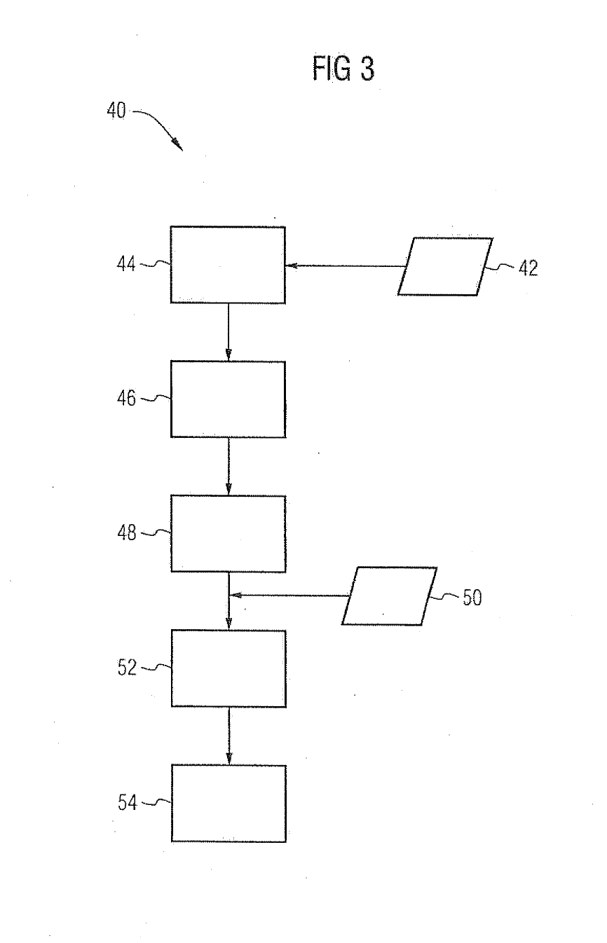

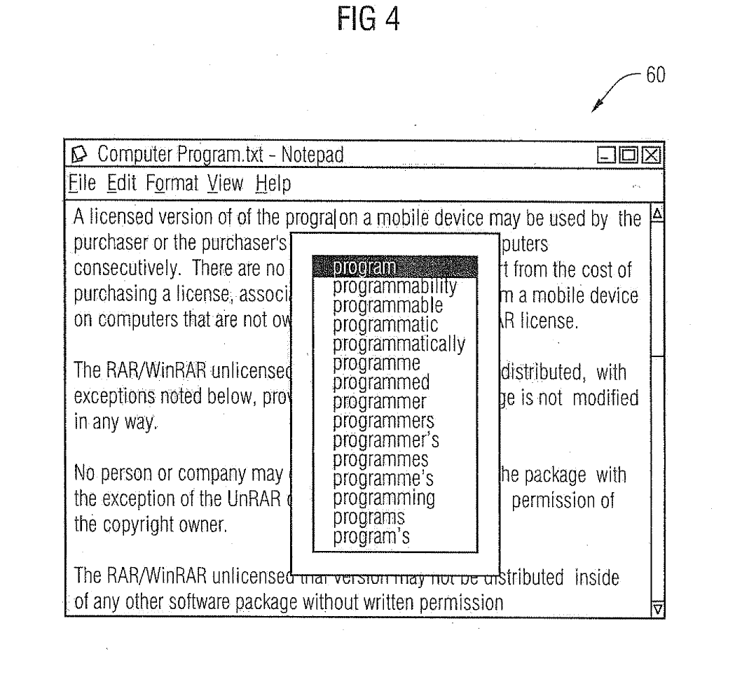

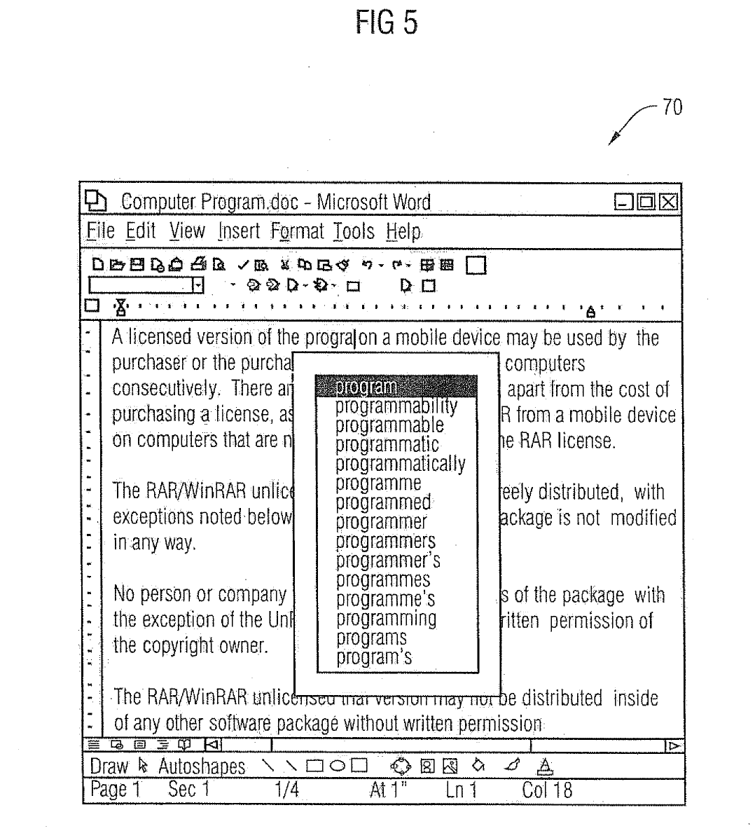

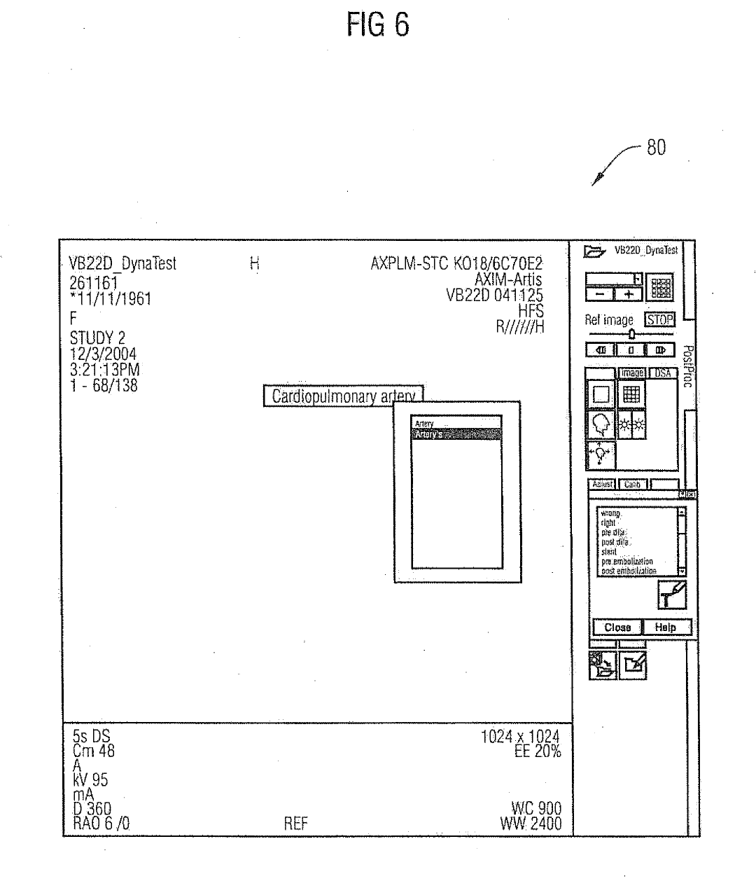

FIG. 3 illustrates an exemplary computer implemented method 40 for providing a feature of auto-completion of dictionary words to an application. The application may be any text editor, such as Notepad, word processing application, such as MS Word, or any other application, such as a medical application. Referring to FIG. 3, at block 42, a user interacts with the application by typing a character by a key press through a keyboard. This user interaction is intercepted (block 44) and communicated to the service providing component (block 46) along with information on the process state and process resources of the application. As described earlier, the service providing component is a heavy weight component that has the business logic to provide the added feature of auto completion to the application by simulation technique. In this example the service providing component receives the intercepted key presses and the process state and process resources from the intercepting code running in the process space of the application and, at block 48, displays the probable dictionary words beginning with the characters that the user has typed in the text window of the application. FIG. 4 is an exemplary screenshot 60 illustrating the addition of the auto-completion feature in Notepad, which displays a list of probable English dictionary words beginning with the characters “progra”. FIG. 5 is an exemplary screenshot 70 illustrating how the auto-completion feature in MS Word application displays a list of probable English dictionary words beginning with the characters “progra”. FIG. 6 is an exemplary screenshot 80 illustrating the auto-completion feature in a medical application that displays a list of probable English dictionary words beginning with the characters “artery”.

Referring back to FIG. 3, at block 50, the user selects a word from the displayed list, whereupon, at block 52, the service providing component simulates the keyboard key press of the characters required to complete the selected word by sending one or more windows keyboard messages to the application. The application assumes that the messages are generated due to key press by the user and completes the word in the text box (block 54).

The present invention is advantageous is a number of ways. First, the proposed intercept-simulation model is independent of the technology/language used to develop the application to a very large extent. Hence, the proposed technique can be extended to provide the required feature to a large number of applications. Further, the proposed technique obviates the need to change or modify the source code of the application to which the feature is to be added, which would otherwise increase the turnaround time with respect to the development, testing and maintenance of the application. Further, the intercepting code is a simple and light weight code designed to perform basic intercepting task, the time consumed for which is negligible. So, response time of the application is unaffected by the intercepting code. Also, the increase in memory requirement of the process space while executing the application due to addition of intercepting code is negligible. Further advantageously, the loose coupling between the application and the service providing component through interceptor guarantees that the application will be unaffected even if the service providing component crashes. Also, the simulation technique used makes the application believe that it is actually interacting with the user. Hence, the functionality of the application remains unaffected.

Summarizing, the present invention deals with a system and a method for providing a feature to a software application. The proposed system comprises an intercepting component and a service providing component. The service providing component comprises code adapted for providing said feature to said application. The intercepting component comprises code adapted for intercepting a first user interaction with said application and communicating the intercepted user interaction to the service providing component. The code of the service providing component is adapted to provide said feature to said application by communicating, to said application, a simulation of at least one second user interaction with said application, based upon the intercepted first user interaction communicated by the intercepting component.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. Accordingly, it is intended that the invention be limited only by the spirit and scope of the appended claims.

1. A system for providing a feature to a software application, comprising:
a service providing component comprising code adapted for providing said feature to said application; and
an intercepting component comprising code adapted for intercepting a first user interaction with said application and communicating the intercepted user interaction to the service providing component,
wherein the code of the service providing component is adapted to provide said feature to said application by communicating, to said application, a simulation of at least one second user interaction with said application, based upon the intercepted first user interaction communicated by the intercepting component.

2. The system according to claim 1, wherein the code of the intercepting component resides in a process space of said application.

3. The system according to claim 1, wherein the code of said service providing component is adapted to communicate one or more window messages to said application that simulate said at least one second user interaction with the said application.

4. The system according to claim 1, wherein said first user interaction comprises a key press of a keyboard by a user of said application, wherein the code of the intercepting component comprises a keyboard hook adapted to intercept said key press and communicate said intercepted key press to the service providing component.

5. The system according to claim 1, wherein the code of the intercepting code is further adapted to communicate a process state and a process resource of said application to said service providing component along with the intercepted first user interaction, further wherein the code of the service providing component is adapted to simulate said at least one second user interaction based upon said process state and said process resource of the application communicated by said intercepting component.

6. A computer implemented method, comprising:
intercepting a first user interaction with a software application;
simulating at least one second user interaction with said application, based upon the intercepted first user interaction; and
communicating said simulated at least one second user interaction to said application.

7. The method according to claim 6, wherein the interception of said first user interaction with said application is carried out by a first code residing in a process space of said application.

8. The method according to claim 6, wherein the simulation of said at least second user action is further based upon a process state and a process resource of the application.

9. The method according to claim 6, wherein the simulation of said at least one user interaction with said application is carried out by a second code.

10. The method according to claim 9, wherein the communication of said simulated at least one second user interaction to said application is carried out via one or more window messages communicated to the application by said second code.
